(19) United States
(12) Patent Application Publication
(10) Pub. No.: US 2011/0144918 A1
(43) Pub. Date: Jun. 16, 2011

(54) BIOLOGICAL INFORMATION DISPLAY DEVICE, BIOLOGICAL INFORMATION DISPLAY SYSTEM, STATISTICAL PROCESSING METHOD, AND RECORDING MEDIUM RECORDING THEREON STATISTICAL PROCESSING PROGRAM

(75) Inventor: Tomonori INOUE, Kyoto-shi (JP)

(73) Assignee: OMRON HEALTHCARE CO., LTD., KYOTO-SHI (JP)

(21) Appl. No.: 13/029,715

(22) Filed: Feb. 17, 2011

Related U.S. Application Data
(63) Continuation of application No. PCT/JP2009/066257, filed on Sep. 17, 2009.

(30) Foreign Application Priority Data
Oct. 6, 2008 (JP) 2008-259892

(51) Int. Cl. G06F 17/18; G06F 19/00

(52) U.S. Cl. 702/19; 702/179

(57) ABSTRACT

A biological information display device displays measurement results for a plurality of times, for example, as result information on first measurement results for a plurality of times (S202). When receiving from a user specification of data to be eliminated out of the first measurement results, a second measurement result to use in calculation of a statistical value is specified based on an instruction from the user (S204, S206). Then, the statistical value on the specified second measurement result is calculated (S208), and the calculated statistical value is displayed (S210).

### TECHNICAL FIELD

The present invention relates to biological information display devices, biological information display systems, statistical processing methods, and recording media recording thereon statistical processing programs, and in particular, relates to a biological information display device, a biological information display system, a statistical processing method, and a recording medium recording thereon a statistical processing program, capable of calculating and displaying a statistical value for measurement results of biological information for a plurality of times.

### BACKGROUND ART

A function of measuring biological information such as a blood pressure and recording measurement result data thereof to display the same is generally mounted in medical apparatuses and home health apparatuses. A treatment policy, a trend, and the like can be easily checked and thus is convenient if the recorded measurement result data can be checked (analyzed) later. On the other hand, in a case where data exists which apparently indicates an abnormal value due to various noises and the like at the time of measurement, it is not preferable to use even such data for analysis.

In order to respond to such a problem, proposals have been made as in Patent Document 1 (Japanese Unexamined Patent Publication No. 2007-44419) and Patent Document 2 (Japanese Unexamined Patent Publication No. 2005-224440). Patent Document 1 (Japanese Unexamined Patent Publication No. 2007-44419) describes searching for blood pressure data corresponding to measurement time within a predetermined time period (e.g., ten minutes) from the measurement time of reference blood pressure data out of blood pressure data stored in a memory as specific data and displaying an average value calculated based on specific data as an evaluation index. Patent Document 2 (Japanese Unexamined Patent Publication No. 2005-224440) describes a sphygmomanometer capable of erasing only a measurement result desired by a user out of a plurality of measurement results measured and stored in a memory.

### Prior Art Documents

Patent Documents

Patent Document 1: Japanese Unexamined Patent Publication No. 2007-44419

Patent Document 2: Japanese Unexamined Patent Publication No. 2005-224440

### SUMMARY OF THE INVENTION

### Problems to be Solved by the Invention

According to the invention of Patent Document 1 (Japanese Unexamined Patent Publication No. 2007-44419), whether or not to use a blood pressure value in the calculation of the average value is determined in the distribution of blood pressure values. Therefore, even if a blood pressure value is correctly measured originally, such a value may not be reflected on the calculatin of the average value.

The invention of Patent Document 2 (Japanese Unexamined Patent Publication No. 2005-224440) aims to erase data itself, so that an operator with insufficient medical knowledge may delete the data with a wrong judgment.

The present invention has been devised to solve the problems described above, and it is an object thereof to provide a biological information display device, a biological information display system, a statistical processing method, and a recording medium recording thereon a statistical processing program, capable of accurately selecting data necessary for calculation of a statistical value out of recorded measurement result data without losing the same.

### MEANS FOR SOLVING THE PROBLEM

According to an aspect of this invention, there is provided a biological information display device capable of calculating and displaying a statistical value of measurement results for a plurality of times on biological information, the biological information display device including: a display unit; an operation unit for receiving an instruction from a user; a storage unit for storing the measurement results of the biological information for the plurality of times as first measurement results; and a specification control unit for controlling to specify a second measurement result to be used in the calculation of the statistical value out of the first measurement results. The specification control unit includes a specification processing portion for specifying the second measurement result based on instruction received by the operation unit when result information on the first measurement results is displayed. The specification processing portion specifies the measurement result other than the specified measurement result as the second measurement result when the received instruction indicates specification of data to be eliminated out of the first measurement results, and specifies the specified measurement result as the second measurement result when the received instruction indicates specification of data to calculate out of the first measurement results. The biological information display device further includes a first calculating unit for calculating the statistical value on the specified second measurement result, and the display unit displays the calculated statistical value.

Preferably, the first measurement results each include first measurement value data. The specification control unit displays the first measurement value data on the display unit as the result information, and the first calculating unit calculates the statistical value of second measurement value data contained in the respective second measurement results.

Preferably, each of the first measurement value data is data of a blood pressure value. Each of the first measurement results further includes a plurality of pieces of pulse wave amplitude value data and a plurality of pieces of pressure value data corresponding to the respective pieces of the plurality of pulse wave amplitude value data, and the specification control unit displays a graph of the pulse wave amplitude along a cuff pressure axis on the display unit as the result information.

Preferably, there are further included: a cuff to be wrapped around a predetermined measurement site of a person to be measured; an adjustment unit for adjusting pressure in the cuff; a detection unit for detecting a cuff pressure representing the pressure in the cuff; and a measurement processing unit for measuring a blood pressure value of the person to be measured based on the cuff pressure detected by the detection unit.

Preferably, the specification control unit further includes a second calculating portion for calculating a reliability rate of each of the measurement values based on the first measurement results, and the display unit further displays the reliability rate in correspondence with each piece of the measurement value data as well as the result information.

Preferably, the specification control unit further includes an extracting portion for extracting a specification candidate by the user out of the first measurement value data based on the reliability rate. The display unit displays the measurement value data extracted as the specification candidate so as to be identifiable from the other measurement value data when displaying the result information.

Preferably, the first measurement results each include the first measurement value data as data of a blood pressure value and pulse wave related information, each pulse wave related information further includes a plurality of pieces of pulse wave amplitude value data and a plurality of pieces of pressure value data corresponding to each of the plurality of pieces of pulse wave amplitude value data.

Preferably, the specification control unit displays a graph of the pulse wave amplitude along a cuff pressure axis on the display unit as the result information for each of the first measurement results based on the pulse wave related information.

Preferably, the first calculating unit calculates a statistical value of a pulse waveform contained in each of the second measurement results.

Preferably, the first measurement results represent measurement results for a predetermined number of times.

Preferably, the first measurement results represent the measurement results corresponding to a classification type specified by the user.

Preferably, the classification type is defined in advance as at least one of a time band, identification information of a person to be measured, and a measurement condition.

According to another aspect of this invention, there is provided a biological information display system including a biological information measurement device and a biological information display device, the biological information measurement device including: a measurement processing unit for measuring biological information of a person to be measured; and an output unit for outputting first measurement results for a plurality of times measured by the measurement processing unit. The biological information display device includes: an input unit for inputting the first measurement results; a display unit; an operation unit for receiving an instruction from a user; and a specification control unit for controlling to specify a second measurement result to use in calculation of a statistical value out of the first measurement results. The specification control unit includes a specification processing portion for specifying the second measurement result based on instruction received by the operation unit when result information on the first measurement results is displayed. The specification processing portion specifies the measurement result other than the specified measurement result as the second measurement result when the received instruction indicates specification of data to be eliminated out of the first measurement results, and specifies the specified measurement result as the second measurement result when the received instruction indicates specification of data to calculate out of the first measurement results. The biological information display device further includes a first calculating unit for calculating the statistical value of the specified second measurement result, and the display unit displays the calculated statistical value.

According to still another aspect of this invention, there is provided a statistical processing method for calculating and displaying a statistical value of measurement results for a plurality of times on biological information, the method including the steps of: displaying result information on the first measurement results for a plurality of times; specifying a plurality of second measurement results to use in the calculation of the statistical value out of the first measurement results based on instruction from the user when the result information is displayed; calculating the statistical value on the specified second measurement results; and displaying the calculated statistical value. In the specifying step, the measurement result other than the specified measurement result is specified as the second measurement result when the instruction indicates specification of data to be eliminated out of the first measurement results, and the specified measurement result is specified as the second measurement result when the instruction indicates specification of data to calculate out of the first measurement results.

According to further another aspect of this invention, there is provided a recording medium recording thereon a statistical processing program for calculating and displaying a statistical value of measurement results for a plurality of times on biological information, the program causing a computer to execute the steps of: displaying result information on the first measurement results for a plurality of times; specifying a plurality of second measurement results to use in the calculation of the statistical value out of the first measurement results based on instruction from the user when the result information is displayed; calculating the statistical value on the specified second measurement results; and displaying the calculated statistical value. In the specifying step, the measurement result other than the specified measurement result is specified as the second measurement result when the instruction indicates specification of data to be eliminated out of the first measurement results, and the specified measurement result is specified as the second measurement result when the instruction indicates specification of data to calculate out of the first measurement results.

### EFFECTS OF THE INVENTION

According to the present invention, a highly accurate statistical value can be presented since the calculation with abnormal data being eliminated (measurement result) as determined by an operator can be carried out. Furthermore, an error in data selection can be reset at any time since the data itself is not deleted. As a result, the operator can safely select only the data necessary for the calculation, and a highly reliable biological information display device can be provided.

### BRIEF DESCRIPTION OF THE DRAWINGS

FIG. 1 is a perspective view of an outer appearance of a biological information display device according to a first embodiment of the present invention.

FIG. 2 is a block diagram showing a hardware configuration of the biological information display device according to the first embodiment of the present invention.

FIG. 3 is a functional block diagram showing a functional configuration of the biological information display device according to the first embodiment of the present invention.

FIGS. 4(A) to 4(C) are views each showing a typical example of a pulse wave amplitude obtained in a process of gradually decreasing a cuff pressure.

FIGS. 5(A) and 5(B) are views each for describing a blood pressure calculation method by the oscillometric method.

FIGS. 6(A) to 6(C) are views each showing an example of the pulse wave amplitude when noise is mixed into the pulse wave.

FIG. 7 is a flowchart showing a flow of a blood pressure measurement process according to the first embodiment of the present invention.

FIG. 8 is a view showing an example of a data structure in a flash memory.

FIG. 9 shows an example of a data structure of pulse wave related information contained in measurement result data.

FIG. 10 is a flowchart showing a statistical process according to the first embodiment of the present invention.

FIGS. 11(A) to 11(D) are views each showing a transition example of a screen displayed in the statistical process according to the first embodiment of the present invention.

FIGS. 12(A) and 12(B) are views each showing a different transition example of the screen displayed in the statistical process according to the first embodiment of the present invention.

FIG. 13 is a flowchart showing a flow of a blood pressure measurement process according to a variant of the first embodiment of the present invention.

FIG. 14 is a view showing an example of a screen displayed in step S202A of FIG. 13.

FIG. 15 is a view showing a concept of a biological information display system according to a second embodiment of the present invention.

FIG. 16 is a hardware block diagram showing an example of a hardware configuration in a biological information display device according to the second embodiment of the present invention.

### MODES FOR CARRYING OUT THE INVENTION

Embodiments of the present invention will be described with reference to the drawings. The same reference symbols are denoted for the same or corresponding portions in the drawings, and the description thereof will not be repeated.

A biological information display device of the present invention calculates and displays a statistical value of the measurement results for a plurality of times regarding biological information. In the present specification, the “biological information” is used in a treatment policy by a medical specialist (medical staff), checking of a trend, and the like, and includes at least one of blood pressure information and a body composition (body fat percentage, basal metabolism, etc.). The “blood pressure information” indicates characteristics of the circulatory system, and includes a pulse wave, and indices that can be calculated from the pulse wave such as a systolic blood pressure, a diastolic blood pressure, an average blood pressure value, a pulse beat, an AI (Augmentation Index) value, and the like.

### [First Embodiment]

### <Regarding Outer Appearance and Configuration>

First, the outer appearance and the configuration of the biological information display device according to a first embodiment of the present invention will be described. In the present embodiment, description will be made assuming that the biological information relates to blood pressures (systolic blood pressure and diastolic blood pressure).

### (Regarding Outer Appearance)

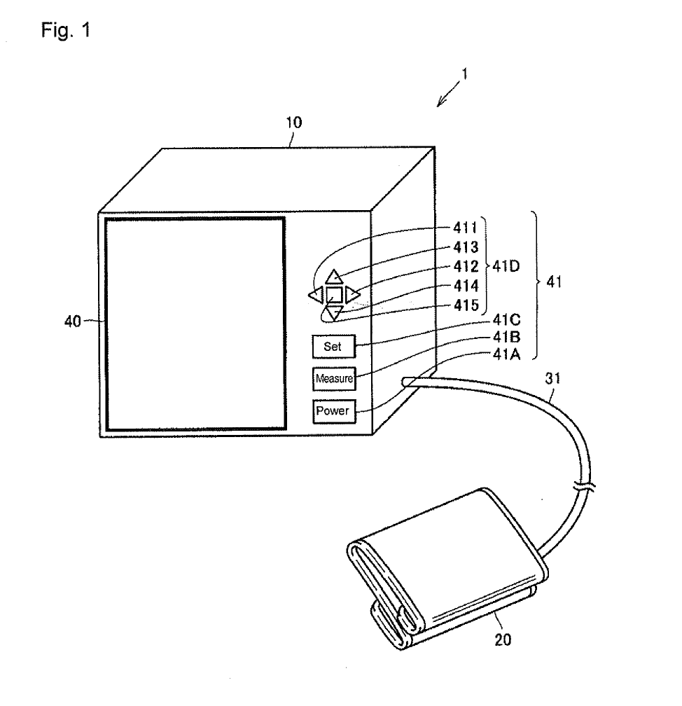

FIG. 1 is a perspective view of an outer appearance of a biological information display device 1 according to a first embodiment of the present invention. The biological information display device 1 has a function of measuring a blood pressure, and thus functions as a sphygmomanometer.

With reference to FIG. 1, the biological information display device 1 includes a main body 10, a cuff 20 that can be wrapped around a predetermined measuring site (e.g., upper arm) of a person to be measured, and an air tube 31 for connecting the main body 10 and the cuff 20. A display unit 40 configured by liquid crystals, and the like, and an operation unit 41 for receiving instructions from a user (representatively a medical staff such as a doctor) are arranged on a surface of the main body 10.

The operation unit 41 includes, for example, a power switch 41A for receiving an input of an instruction to turn ON or OFF the power, a measurement switch 41B for receiving an instruction to start measurement, a set switch 41C for receiving an instruction for various types of setting processes and readout of stored values, and a cursor switch 41D. The cursor switch 41D includes a leftward switch 411, a rightward switch 412, an upward switch 413, a downward switch 414, and a determination switch 415.

The main body 10 of the biological information display device 1 is mounted on a desk or a dedicated stand in an examination room.

### (Regarding Hardware Configuration)

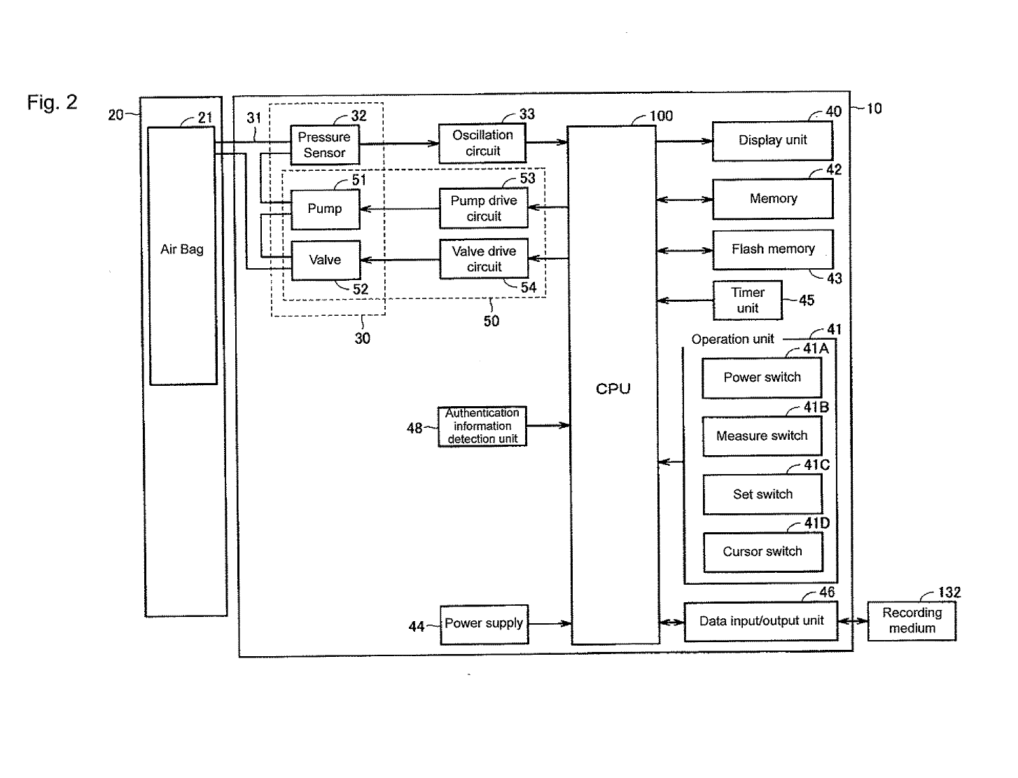

FIG. 2 is a block diagram showing a hardware configuration of the biological information display device 1 according to the first embodiment of the present invention.

With reference to FIG. 2, the cuff 20 of the biological information display device 1 includes an air bag 21. The air bag 21 is connected to an air system 30 through the air tube 31.

In addition to the display unit 40 and the operation unit 41 described above, the main body 10 includes the air system 30, a CPU (Central Processing Unit) 100 for controlling each unit in a concentrated manner and for carrying out various calculation processes, a memory 42 for storing programs causing the CPU 100 to perform predetermined operations and various data, a non-volatile memory (e.g., flash memory) 43 for storing a measured blood pressure, a power supply 44 for supplying power to the CPU 100, a timer unit 45 for performing a timing operation, and a data input/output unit 46 for receiving an input of data from the outside.

The air system 30 includes a pressure sensor 32 for detecting a pressure (cuff pressure) in the air bag 21, a pump 51 for supplying air to the air bag 21 in order to increase the cuff pressure, and a valve 52 that opens and closes to exhaust or enclose the air in the air bag 21.

The main body 10 also includes an oscillation circuit 33, a pump drive circuit 53, and a valve drive circuit 54 in association with the air system 30 described above.

The pressure sensor 32 is a capacitance type pressure sensor, where the capacitance value changes according to the cuff pressure. The oscillation circuit 33 outputs to the CPU 100 a signal of an oscillating frequency corresponding to the capacitance value of the pressure sensor 32. The CPU 100 converts the signal obtained from the oscillation circuit 33 to a pressure and detects the pressure. The pump drive circuit 53 controls the drive of the pump 51 based on a control signal provided from the CPU 100. The valve drive circuit 54 performs the open/close control of the valve 52 based on a control signal provided from the CPU 100.

The pump 51, the valve 52, the pump drive circuit 53, and the valve drive circuit 54 configure an adjustment unit 50 for adjusting the cuff pressure. It should be recognized that the device for adjusting the cuff pressure is not limited thereto.

The data input/output unit 46 performs read and write of programs and data from/in a removable recording medium 132. Further/Alternatively, the data input/output unit 46 may transmit and receive programs and data through a communication line to/from an external computer (not shown).

Although the cuff 20 includes the air bag 21, a fluid supplied to the cuff 20 is not limited to air and may be a liquid or a gel. Alternatively, the fluid is not the sole case, and uniform fine particles such as microbeads may be used.

### (Regarding Functional Configuration)

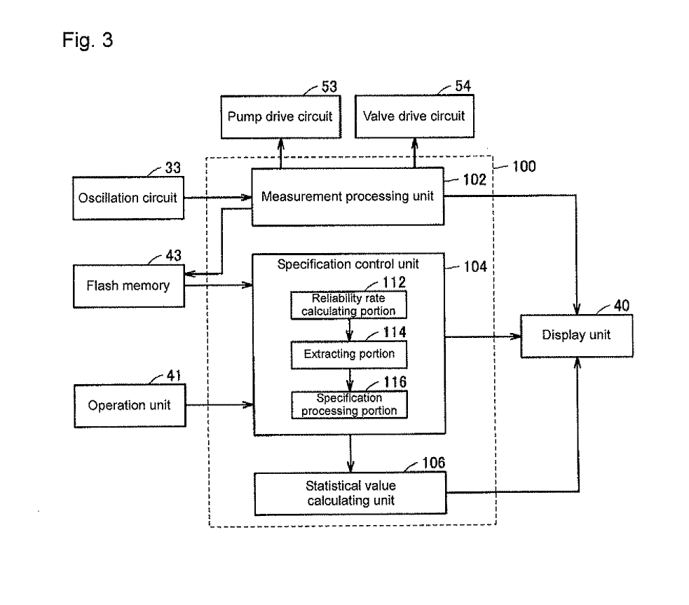

FIG. 3 is a functional block diagram showing a functional configuration of the biological information display device 1 according to the first embodiment of the present invention. FIG. 3 only shows peripheral hardware that directly exchanges signals with each unit of the CPU 100 for the sake of simplifying the explanation.

With reference to FIG. 3, the CPU 100 includes a measurement process unit 102, a specification control unit 104, and a statistical value calculating unit 106.

The measurement processing unit 102 is connected to the oscillation circuit 33, the pump drive circuit 53, and the valve drive circuit 54, and performs a process for measuring blood pressure values (systolic blood pressure and diastolic blood pressure) of a person to be measured according to a predetermined algorithm. Suppose that the algorithm for calculating the blood pressure does not include the correction algorithm for smoothening a pulse wave amplitude. In the present embodiment, the measurement processing unit 102 executes continuous measurements for a predetermined number of times, but this is not the sole case. The measurement processing unit 102 stores measurement result data including the measured blood pressure values in the flash memory 43. The data structure of the flash memory 43 will be described later.

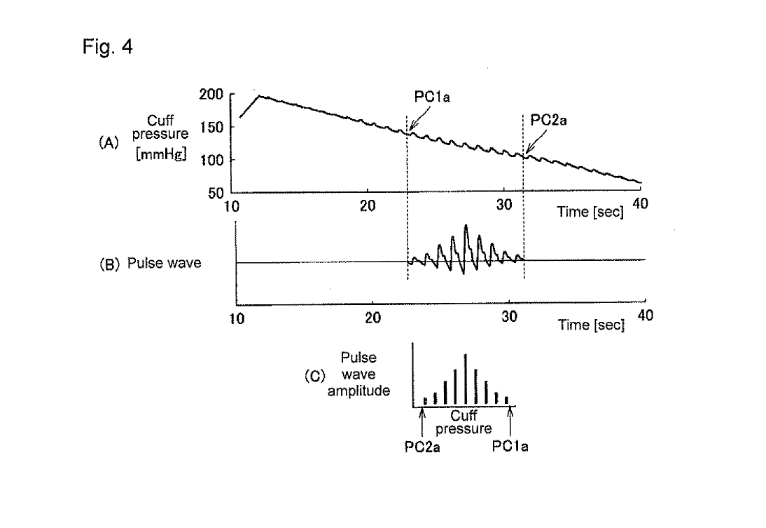

The measurement processing unit 102 calculates the blood pressure values according to the oscillometric method. First, the blood pressure calculation method by the oscillometric method will be briefly described with reference to FIGS. 4(A) to 6(C).

FIGS. 4(A) to 4(C) are views each showing a typical example of a pulse wave amplitude obtained in the process of gradually decreasing the cuff pressure. In FIG. 4(A), a signal of the detected cuff pressure (unit: mmHg) is shown along a time axis. In FIG. 4(B), pulse wave components after a filtering process is shown along the same time axis as the graph of FIG. 4(A). In FIG. 4(C), the amplitude value of the pulse wave component for each beat shown in FIG. 4(B) is shown along a cuff pressure axis. A cuff pressure PC1a shown on the cuff pressure axis of FIGS. 4(A) and 4(C) is a pressure value at the time point the pulse wave starts to be detected, and a cuff pressure PC2a is a pressure value at the time point the pulse wave is no longer detected.

The blood flow arrests when the inner pressure of the cuff becomes higher than the systolic blood pressure, and the blood flow resumes when the pressure is gradually released. The oscillometric method uses the characteristics that the pulse wave amplitude changes in the process as shown in FIG. 4(C).

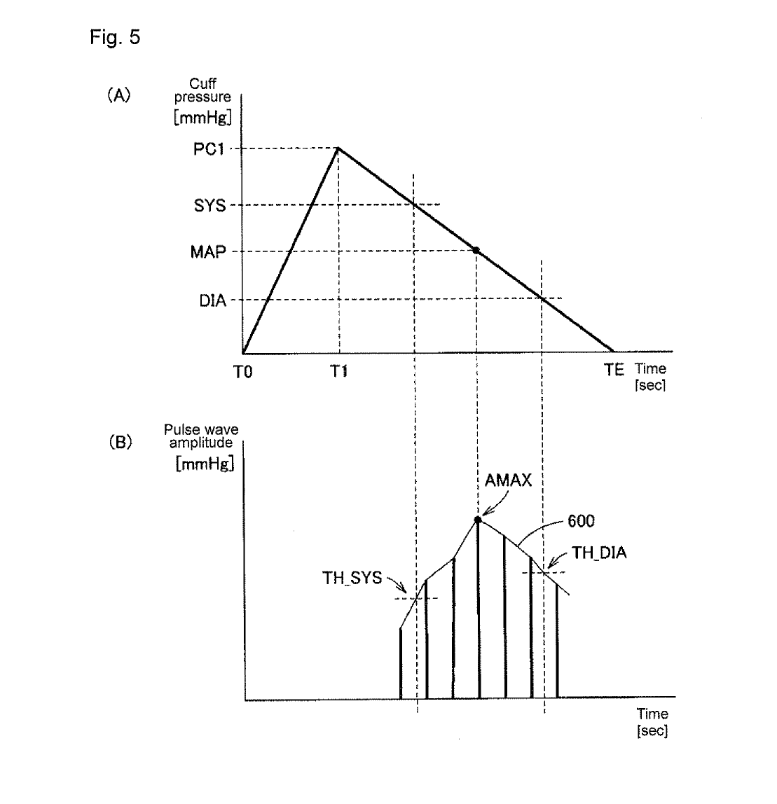

FIGS. 5(A) and 5(B) are views each for describing the blood pressure calculation method by the oscillometric method. FIG. 5(A) shows the cuff pressure (unit: mmHg) that gradually changes along the time axis, and FIG. 5(B) partially shows the pulse wave amplitude (unit: mmHg) for every beat superimposed on the cuff pressure along the same time axis.

With reference to FIG. 5(A), the cuff pressure is increased to be higher than or equal to the systolic blood pressure (“PC1” in the figure) of the person to be measured and is then decreased at a constant speed. A predetermined algorithm is applied to the pulse wave amplitude superimposed on the detected cuff pressure at the gradually depressurizing stage to calculate the systolic blood pressure and the diastolic blood pressure. With reference to FIG. 5(B), the cuff pressure corresponding to a point AMAX, at which the pulse wave amplitude becomes a maximum during the decrease of the cuff pressure, is found to be an average blood pressure (“MAP” in the figure) in the oscillometric method.

When the maximum point of the pulse wave amplitude is detected, a value obtained by multiplying a predetermined constant (e.g., 0.5) to the maximum point AMAX is assumed as a threshold value TH_SYS, and a value obtained by multiplying a predetermined constant (e.g., 0.7) to the maximum point AMAX is assumed as a threshold value TH_DIA. The cuff pressure higher than the average blood pressure (MAP) and corresponding to the point where an envelope curve 600 of the pulse wave amplitude and the threshold value TH_SYS intersect is determined as s systolic blood pressure (“SYS” in the figure). The cuff pressure lower than the average blood pressure (MAP) and corresponding to the point where the envelope curve 600 of the pulse wave amplitude and the threshold value TH_DIA intersect is determined as a diastolic blood pressure (“DIA” in the figure).

As apparent from this figure, the shape of the envelope curve of the pulse wave amplitude influences the accuracy of the blood pressure value calculation in the oscillometric method. In FIGS. 5(A) and 5(B), the depressurization measurement method (method of calculating the blood pressure based on the pulse wave measured during depressurization) has been described as an example, but the same also applies to the pressurization measurement method.

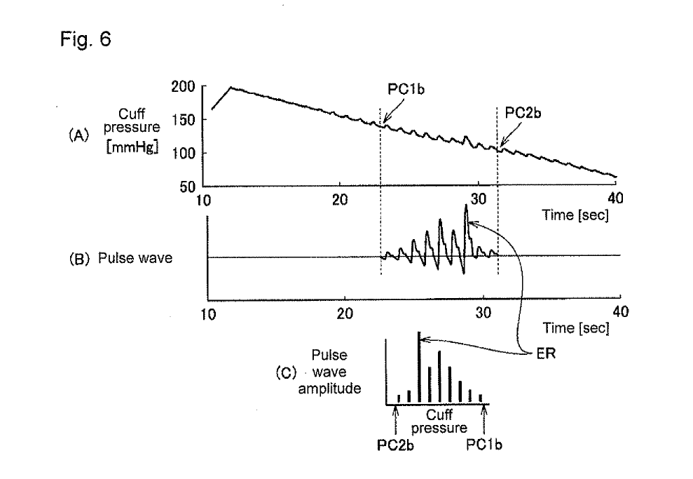

FIGS. 6(A) to 6(C) are views each showing an example of the pulse wave amplitude when noise is mixed into the pulse wave. The graphs of FIGS. 6(A), 6(B), and 6(C) respectively correspond to the graphs of FIGS. 4(A), 4(B), and 4(C). In FIG. 6(C), there exits a pulse wave amplitude ER that has an apparently abnormal value out of a plurality of pulse wave amplitudes. If the blood pressure is calculated based on such a plurality of pulse wave amplitudes, the cuff pressure at the time point the amplitude ER is detected is determined as the average blood pressure, and hence an inaccurate blood pressure value will be calculated. Even with a sphygmomanometer mounting a correction algorithm for automatically detecting noise and removing the detected noise, what kind of process is being carried out inside is unknown in most cases. Even if the process is known, a wrong correction process may be carried out for a medical staff, in which case measurement needs to be carried out again.

The existence of the abnormal pulse wave amplitude ER as shown in FIG. 6(C) can be easily found by a medical staff (medical person) having sufficient knowledge on blood pressures. The medical staff can also determine as an abnormal blood pressure value, that is, a blood pressure value superimposed with noise, by simply checking the blood pressure values for a plurality of times.

In the present embodiment, when a plurality of measurement results as targets are displayed before the calculation of the statistical value, determination of a measurement result not suitable for the calculation of the statistical value can be made out of the plurality of displayed measurement results. In the present embodiment, the measurement result specified as an eliminating target by the user is not used for the calculation of the statistical value, but the calculation can be redone as many times as required even in a case where the determination is wrongly made by not deleting from the memory (flash memory 43). As a result, the diagnosis of the person to be measured by the medical staff can be supported since an accurate statistical value can be calculated. The medical staff can safely perform the operation for specification since the measurement result specified as the eliminating target is not deleted from the memory.

Referring again to FIG. 3, the specification control unit 104 performs control for specifying at least one second measurement result used for the calculation of the statistical value out of a plurality of first measurement results. In the present embodiment, the “plurality of first measurement results” are for an immediate predetermined number of times. When an instruction for calculating the statistical value is input by the user or when the continuous measurements of the blood pressures are terminated, the specification control unit 104 displays result information on the measurement results for the predetermined number of times. The displayed result information includes at least the blood pressure value data (also referred to as “first blood pressure value data”) for the predetermined number of times stored in the flash memory 43 and/or preferably includes pulse wave amplitude information (e.g., graph) for every first blood pressure value data.

The specification control unit 104 includes a specification processing portion 116. When the above result information is displayed, the specification processing portion 116 executes a process for specifying the second measurement result to be used in the calculation of the statistical value based on an instruction signal from the operation unit 41. More specifically, a plurality of blood pressure value data (also referred to as “second blood pressure value data”) to be used in the calculation of the statistical value is specified out of the first blood pressure value data for the predetermined number of times. When a predetermined instruction is input by the operation unit 41, the specification processing portion 116 can reset the specification regarding the second blood pressure value data.

In FIG. 3, a reliability rate calculating portion 112 and an extracting portion 114 used in a variant to be described later are also shown for the sake of simplifying the description, but they are assumed to be not included in the specification control unit 104 in the present embodiment.

The statistical value calculating unit 106 calculates the statistical value of the second measurement result specified by the specification processing portion 116. The calculated statistical value is displayed on the display unit 40.

The operation of each functional block described above may be realized by executing software stored in the memory 42, or at least one may be realized by hardware.

### <Regarding Operation>

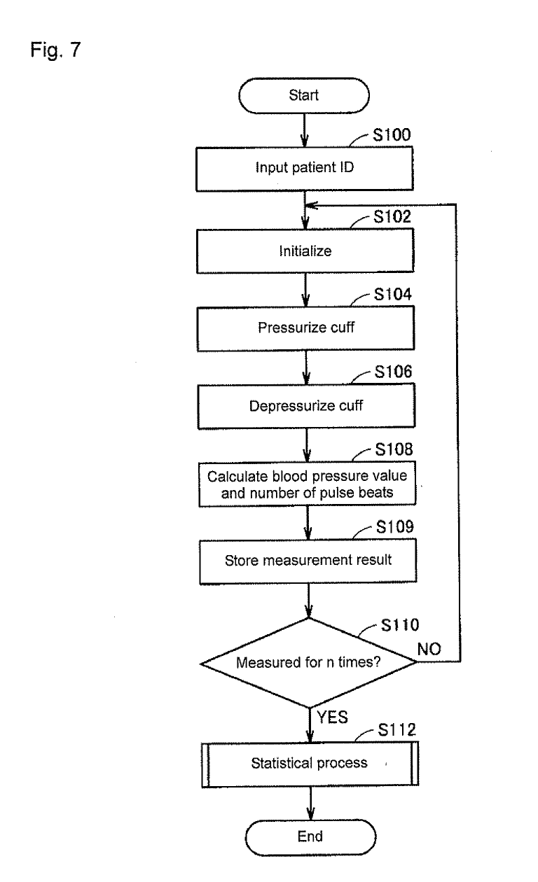

FIG. 7 is a flowchart showing the flow of a blood pressure measurement process according to the first embodiment of the present invention. The program according to the flowchart is stored in advance in the memory 42, and the function of the blood pressure measurement process is realized when the CPU 100 reads out and executes the program. The following process is assumed to start when push of the power switch 41A is detected. The operation of the operation unit 41 including the power switch 41A is assumed to be carried out by a medical staff. Therefore, subsequent processes may be started only when a predetermined operation (e.g., simultaneous push of a plurality of switches etc.) is carried out after the push of the power switch 41A. Alternatively, the biological information display device 1 may include an authentication information detection unit 48 (see FIG. 2) for detecting authentication information of the user. In this case, the CPU 100 may start subsequent processes only when determined that the authentication information detected by the authentication information detection unit 48 is matched with the authentication information stored in the memory 42 in advance. A fingerprint or information recorded on an ID card is adopted as the authentication information.

With reference to FIG. 7, the CPU 100 first receives input of a patient ID based on a signal from the operation unit 41 (step S100). When the measurement switch 41 B is pushed thereafter, the continuous measurements of the blood pressure values are executed according to a known method.

Specifically, the measurement processing unit 102 executes an initialization process (step S102). Particularly, a predetermined region of the memory 42 is initialized, the air in the air bag 21 is exhausted, and correction of the pressure sensor 32 is performed. When the measurable state is then realized, the measurement processing unit 102 starts to drive the pump 51 and gradually increases the cuff pressure of the air bag 21 (step S104).

When the cuff pressure reaches a predetermined level for blood pressure measurement in the gradually pressurizing process, the measurement processing unit 102 gradually decreases the cuff pressure (step S106). Specifically, the pump 51 is stopped and the closed valve 52 is gradually opened to gradually exhaust the air in the air bag 21. The measurement processing unit 102 acquires a signal from the oscillation circuit 33 and detects the cuff pressure during the depressurization period. The detected cuff pressure data is then recorded in time-series in an internal memory. In the present embodiment, the pulse wave is measured in the course of decreasing the cuff pressure but may be measured in the course of increasing the cuff pressure.

The measurement processing unit 102 extracts the pulse wave amplitude (pulse wave amplitude value for a plurality of beats) as a vibration component from the measured pulse wave according to the oscillometric method described above, and calculates blood pressure values (systolic blood pressure and diastolic blood pressure) and the number of pulse beats (step S108). Each extracted pulse wave amplitude value is stored in the internal memory in correspondence with the cuff pressure data or the time data. After the blood pressure values are calculated, the measurement result for this time is stored in a corresponding measurement result storage region of the flash memory 43 (step S109).

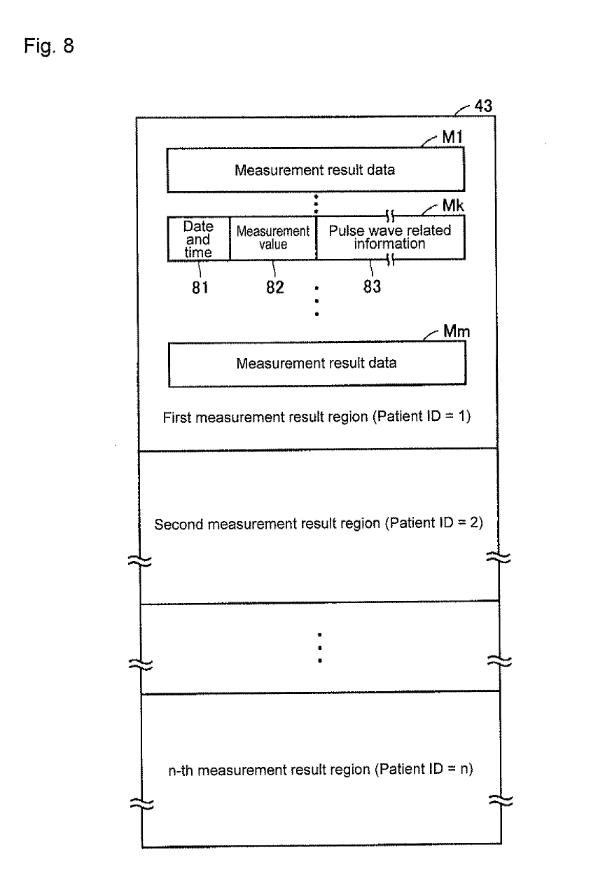

An example of a data structure in the flash memory 43 in the present embodiment is shown in FIG. 8. With reference to FIG. 8, the flash memory 43 includes the measurement result region for every patient ID. Each measurement result region stores therein measurement result data M1 to Mm (m=1, 2, 3, . . . ) for every one measurement. Each measurement result data Mk includes date and time data 81 representing the measurement date and time, measurement value data 82 including the systolic blood pressure data, the diastolic blood pressure data, and the number of pulse beats data, and pulse wave related information 83. The measurement value data 82 may not include the number of pulse beats data. The measurement value data, the measurement date and time data, and the pulse wave related information merely need to be in correspondence with one another for every measurement, but are not limited to such a storing form. The pulse wave related information may not necessarily be included in the measurement result data.

In step S109 of FIG. 7, the measurement result data is stored in the measurement result storage region corresponding to the patient ID input in step S100.

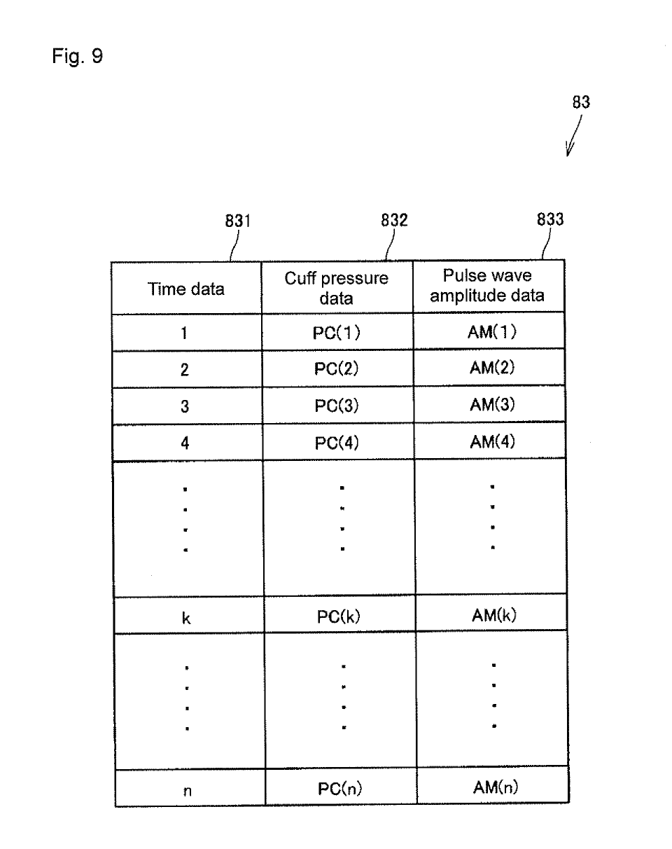

An example of a data structure of the pulse wave related information 83 is shown in FIG. 9. With reference to FIG. 9, the pulse wave related information 83 includes three items, namely, an item 831 indicating the time data, an item 832 indicating the cuff pressure data, and an item 833 indicating the extracted pulse wave amplitude data. The cuff pressure data is stored in correspondence with the time data representing the time when the cuff pressure is detected, and the pulse wave amplitude data merely needs to be stored in correspondence with the time data or the cuff pressure data. Assume that the numerical value including “0” is recorded in the pulse wave amplitude data.

With reference again to FIG. 7, the measurement processing unit 102 determines whether or not measurements for a predetermined number of times N (e.g., six times) are executed (step S110). When determined as less than six times (NO in step S110), the process returns to step S102 and the series of steps are repeated. When determined that the measurements are terminated for six times (YES in step S110), the statistical process is executed (step S112).

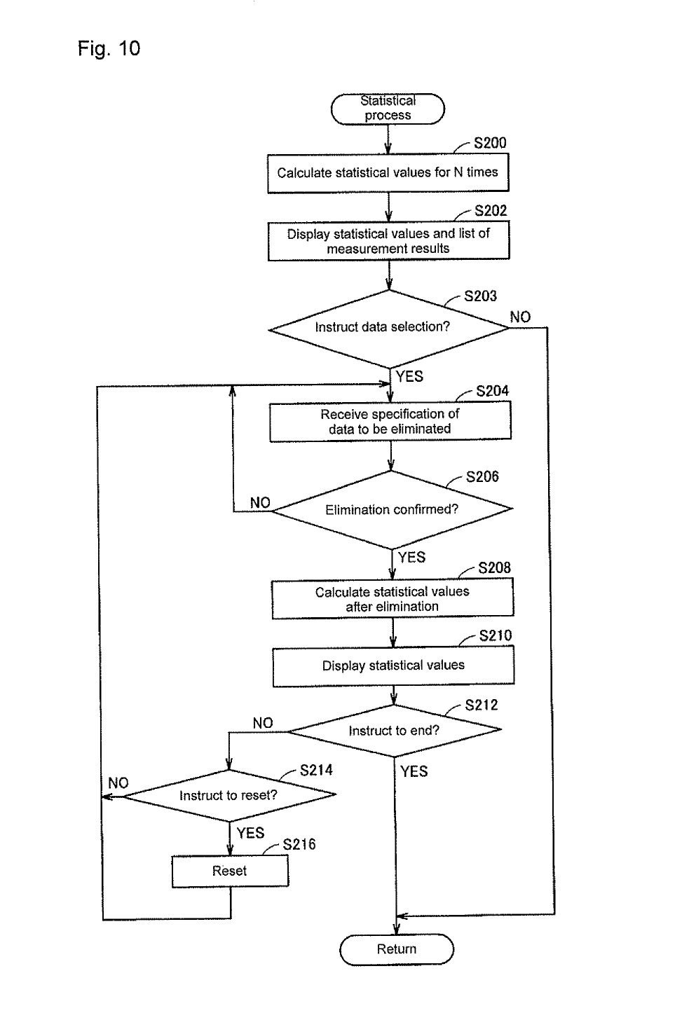

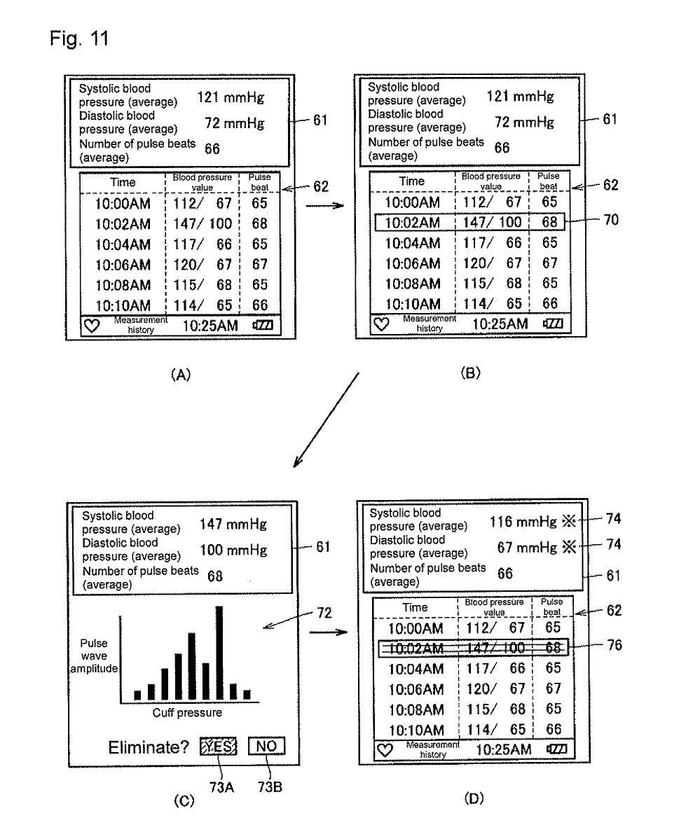

The statistical process will be described with reference to the sub-routine of FIG. 10 and FIGS. 11(A) to 11(D). FIG. 10 is a flowchart showing the statistical process according to the first embodiment of the present invention. FIGS. 11(A) to 11(D) are views each showing a transition example of a screen displayed in the statistical process according to the first embodiment of the present invention.

With reference to FIG. 10, the statistical value calculating unit 106 first calculates statistical values such as average values of the continuously measured measurement values (systolic blood pressure, diastolic blood pressure, and the number of pulse beats) for N times (six times) (step S200). When starting the statistical process, the date and time data 81 and the measurement value data 82 out of the measurement result data for six times are assumed to be read out from the flash memory 43 and developed in the internal memory.

The specification control unit 104 then displays the calculated average values and the measurement result list on the display unit 40 (step S202). The example of screen display is shown in FIG. 11(A).

With reference to FIG. 11(A), the statistical values of the measurement values for six times calculated in step S200 are displayed in a predetermined region 61 of the display unit 40. Specifically, there are displayed the average value of the systolic blood pressure, the average value of the diastolic blood pressure, and the average value of the number of pulse beats. A measurement result list 62 is displayed below the region 61. The measurement result list 62 is configured by the time item, the blood pressure value (systolic blood pressure/diastolic blood pressure) item, and the pulse beat item, in which the values of such items contained in the respective measurement result data for six times are displayed in the list. Each row configuring the measurement result list 62 is referred to as the “measurement data” in the following description.

The medical staff can decide whether or not there is a blood pressure that is abnormal or that is not suitable for the calculation of the statistical values by looking at the six pieces of measurement data configuring the measurement result list 62.

The specification control unit 104 then determines whether or not a data selecting instruction is input through the operation unit 41 (step S203). If the data selecting instruction is not input (NO in step S203), the process is terminated.

When the data selecting instruction is input (YES in step S203), the specification processing portion 116 of the specification control unit 104 receives specification of the measurement data as an eliminating candidate from the medical staff (step S204). The examples of display screens upon receiving the specification of the measurement data as the eliminating candidate are shown in FIGS. 11(B) and 11(C).

FIG. 11(B) shows an example in which one piece of measurement data 70 is selected as the eliminating candidate as a result of operation of the cursor switch 41D. The specification processing portion 116 stores, for example, a flag (F=1) (hereinafter referred to as an “eliminating flag”) for identifying that the measurement value (hereinafter referred to as “selected measurement value”) contained in the measurement data 70 selected as the eliminating candidate is the data as the eliminating target (eliminating candidate at this stage) in correspondence with the selected measurement value.

When the determination switch 415 is pushed, for example, while the measurement data 70 is selected, the specification processing portion 116 preferably reads out the pulse wave related information 83 corresponding to the measurement data 70 from the flash memory 43 and displays the screen as shown in FIG. 11(C).

In FIG. 11(C), a graph 72 showing the pulse wave amplitude along the cuff pressure axis (or the time axis) is displayed instead of the measurement result list 62. The graph 72 shows the change in the pulse wave amplitude according to the pressurization of the cuff 20 used in the calculation of the blood pressure value (hereinafter referred to as a “selected blood pressure value”) contained in the selected measurement value. The medical staff can easily determine whether or not the selected blood pressure value is an abnormal value containing noise, that is, whether or not data suitable to be used for the calculation of the statistical values by displaying the graph 72.

A button 73A for confirming that the selected measurement value is set as the eliminating target and a button 73B for confirming that the selected measurement value is not set as the eliminating target are displayed under the graph 72. For instance, when the button 73A is pushed (YES in step S206), the measurement value without having the eliminating flag, that is, the measurement value specified by the user, is specified as the measurement value to be used in the calculation of the average values by the specification processing portion 116. The statistical value calculating unit 106 then calculates the statistical values for the plurality of measurement values with the selected measurement value being eliminated (step S208). Specifically, calculated are the average values of the respective measurement values (systolic blood pressure, diastolic blood pressure, and the number of pulse beats) without having the eliminating flags. The calculated average values are displayed on the display unit 40 (step S210).

FIG. 11(D) is a view showing an example of a screen displayed in step S210 of FIG. 10. With reference to FIG. 11(D), the average values (average value of systolic blood pressure, average value of diastolic blood pressure, and average value of the number of pulse beats) after the elimination of the selected measurement value are displayed in the region 61. The measurement data 70 including the measurement value confirmed as the eliminating target in the measurement result list 62 is shown with a double canceling line, etc. to show that it is eliminated. A mark (e.g., “*”) 74 indicating the average value after the elimination of at least one piece of data is preferably displayed near each of the average value of the systolic blood pressure and the average value of the diastolic blood pressure displayed in the region 61. Notification may be made that the average value being displayed is obtained after the elimination with use of an LED (Light Emitting Diode) or a buzzer (not shown) instead of displaying the mark 74.

When the button 73B shown in FIG. 11(C) is pushed (NO in step S206), the process returns to step S204, and the screen as shown in FIG. 11(B) is again displayed.

After step S210, the specification control unit 104 determines whether or not the instruction for termination is input (step S212). When determined that the instruction for termination is input (YES in step S212), the statistical process is terminated. When the instruction for termination is not input (NO in step S212), the process proceeds to step S214.

In step S214, the specification control unit 104 determines whether or not the instruction for reset is input. When determined that the instruction for reset is input (YES in step S214), the eliminating flag is cleared to be reset into a state with no eliminating target (step S216), and the process returns to step S204. When the instruction for reset is not input (NO in step S214), the process returns to step S204 without clearing the eliminating flag.

Thus, in the present embodiment, the eliminating target can be specified as many times as required even if erroneously determined as the eliminating target since the measurement result data itself eliminated from the calculation of the average values is not deleted from the flash memory 43. Furthermore, the medical staff can easily determine whether or not the corresponding blood pressure value is abnormal data since the graph of the pulse wave amplitude used in the calculation of the blood pressure value is also displayed in addition to the blood pressure value when selecting the eliminating target.

In the present embodiment, the measurement result data may be automatically deleted only when the flash memory 43 has a predetermined capacity. In such a case, the oldest data may be deleted, for example.

In the above-described embodiment, the graph of the pulse wave amplitude value is displayed only for the selected blood pressure value, but the graph of the pulse wave amplitudes for N times may be displayed at once in addition to/in place of the blood pressure values for N times in a case where the display region of the display unit 40 is large. Furthermore, the graph of the pulse wave amplitude value is displayed in the present embodiment, but the filtered pulse wave may be alternatively displayed along the time axis.

In the flowchart of FIG. 10, the statistical values for N measurement values are calculated and displayed at the time point transition is made to the statistical process, but the statistical values may be calculated and displayed for the first time at the time point the eliminating target is confirmed. In this case, the statistical values for N measurement values are calculated and displayed when the instruction not to select data is input (NO in step S203).

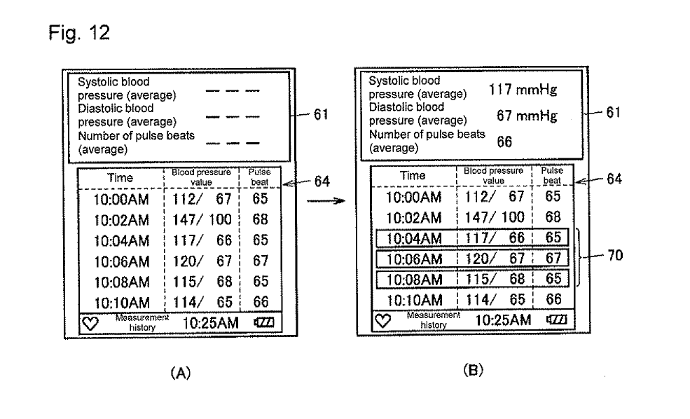

In the present embodiment, the measurement data as the eliminating target is selected by the medical staff, but the measurement data to be used in the calculation of the average value out of the measurement data for N times may be selected by the medical staff. FIGS. 12(A) and 12(B) are views each showing another transition example of a screen displayed in the statistical process according to the first embodiment of the present invention.

FIG. 12(A) shows an example of a screen displayed in step S202 of FIG. 10. In this case, no numerical value is displayed in the region 61 of the display unit 40 since the average value is not yet calculated. FIG. 12(B) shows a state in which three pieces of measurement data 70 out of the measurement data for six times are selected as data to be used in the calculation of the average value. Thus, when one or more pieces of measurement data is selected, the selected measurement value, that is, the measurement value specified by the user is specified as the measurement value to be used in the calculation of the average value by the specification processing portion 116. Thus, the average value of the respective measurement values contained in the three pieces of selected measurement data 70 is displayed in the region 61.

Furthermore, in the present embodiment, the measurement results for N times are displayed after the termination of the continuous measurements for N times and then the specification of the measurement data as the eliminating target is received. Alternatively, the measurement result may be displayed every time one measurement is terminated so as to select each time whether or not to select the result as the eliminating target.

The number of continuous measurements is set to a predetermined number of times but may be set and changed by the user (medical staff). Further, all measurement values corresponding to the specified person to be measured (patient ID) may be set as the targets regardless of whether or not the continuous measurement function is provided.

It is assumed to be used by a plurality of people to be measured in the present embodiment, but use may be made only by one person to be measured with such as a portable sphygmomanometer. In such a case, the most recent blood pressure values for a specified number of times (e.g., a predetermined number of times) out of the blood pressure values (measurement values) for a plurality of times measured in the past may simply be set as the targets.

Alternatively, the measurement values measured in a specific time band (morning time band, evening time band, etc.) or in a specific period (one day, one week, one month, etc.) may be set as the targets. The specific time band and the specific period may be respectively defined in advance or may be specified by the user. Further alternatively, input of measurement conditions may be received at the time of the measurement, and the information on the measurement conditions may also be included in the measurement result data. In this case, the measurement value in accordance with the measurement conditions specified by the user may be set as the target. The measurement conditions include at least one of the measuring place (e.g., office, home, etc.) and an administration result.

In the present embodiment, the average value is adopted for the statistical value, but may be a most frequent value, a maximum value, a minimum value, a deviation, a weighted average, or the like as long as it is a statistical value. A trend graph or a rate of change of the measurement values for a plurality of times may be calculated in addition to/in place of the statistical value of the measurement values for a plurality of times.

### <Variant>

A variant of the first embodiment of the present invention will be described next. The specification control unit 104 further includes a reliability rate calculating portion 112 and an extracting portion 114.

The reliability rate calculating portion 112 calculates a reliability rate of each measurement value based on the measurement result data for N times. The extracting portion 114 extracts a measurement value as an eliminating candidate out of the measurement values for N times based on the reliability rate calculated by the reliability rate calculating portion 112.

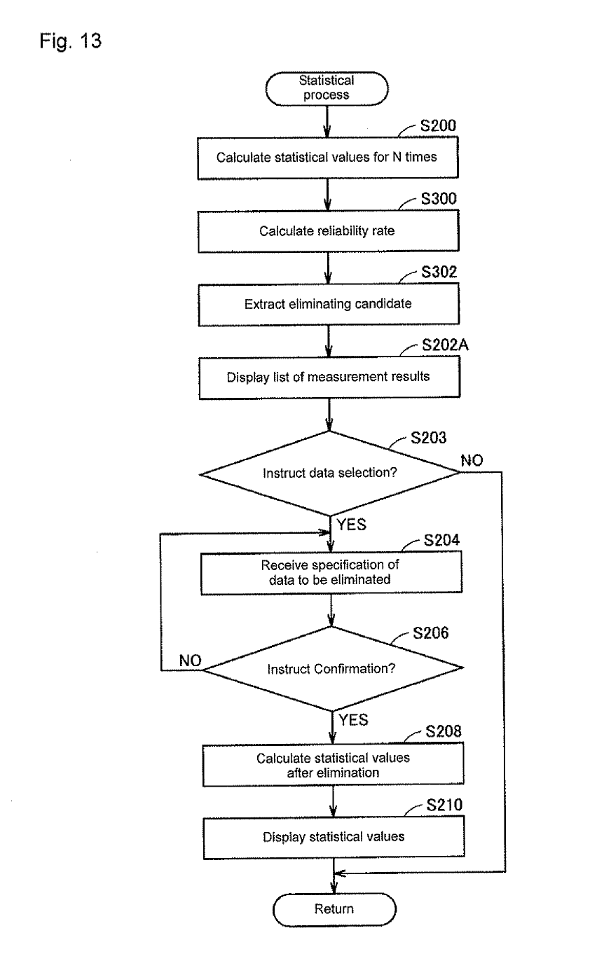

FIG. 13 is a flowchart showing a flow of a blood pressure measurement process according to the variant of the first embodiment of the present invention. The steps same as those of the flowchart shown in FIG. 7 are denoted by the same step numbers. Therefore, the description on these steps will not be repeated.

With reference to FIG. 13, in the present variant, steps S300 and S302 are inserted between the processing in step S200 and the processing in step S202. Further, step S202A is executed in place of step S202.

In step S300, the reliability rate calculating portion 112 calculates a reliability rate of the blood pressure values for N times. A correction rate in a case where a median process or the like is performed on pulse wave amplitude value series (pulse wave amplitude values for a plurality of beats) to smoothen the same may be used for the calculation of the reliability rate. Specifically, the calculation can be made as “reliability rate (%)=100−correction rate”. The calculation of the correction rate is conventionally carried out as described in Japanese Unexamined Patent Publication No. H07-236617. The method of calculating the reliability rate is not particularly limited and any method other than the above may be used.

In step S302, the extracting portion 114 extracts the blood pressure value as the eliminating candidate out of the N blood pressure values based on the reliability rate calculated in step S300. Specifically, for instance, the blood pressure value of which reliability rate is smaller than a specific value is determined as the eliminating candidate. The specific value in this case may be a predetermined value (e.g., 80%) or may be a value set by the user.

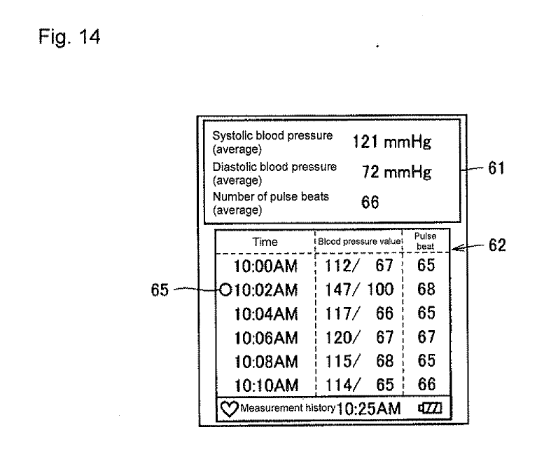

In step S202A, the measurement data on the blood pressure value extracted as the eliminating candidate in step S302 is displayed so as to be identifiable from other measurement data. An example of a display screen is shown in FIG. 14.

With reference to FIG. 14, the average values of six blood pressure values are displayed in the region 61, while a predetermined mark 65 is displayed near the measurement data second from the top determined as the eliminating candidate out of the six pieces of measurement data configuring the measurement result list 62. The medical staff thus can easily determine the measurement data as the eliminating target.

The eliminating candidate is extracted and the measurement data set to the eliminating candidate is displayed so as to be identifiable from other measurement data, but in addition to/in place thereof, the reliability rates for respective measurement values calculated in step S300 may be displayed in association with the measurement values.

### [Second Embodiment]

In the first embodiment and the variant thereof, the biological information display device performs both the measurement of the biological information (e.g., blood pressure) and the statistical process (calculation and display of statistical values). In a second embodiment of the present invention, on the other hand, the respective processes are executed in different devices.

The biological information is assumed to be the blood pressure in the present embodiment as well, and only the portions different from those of the first embodiment will be described below.

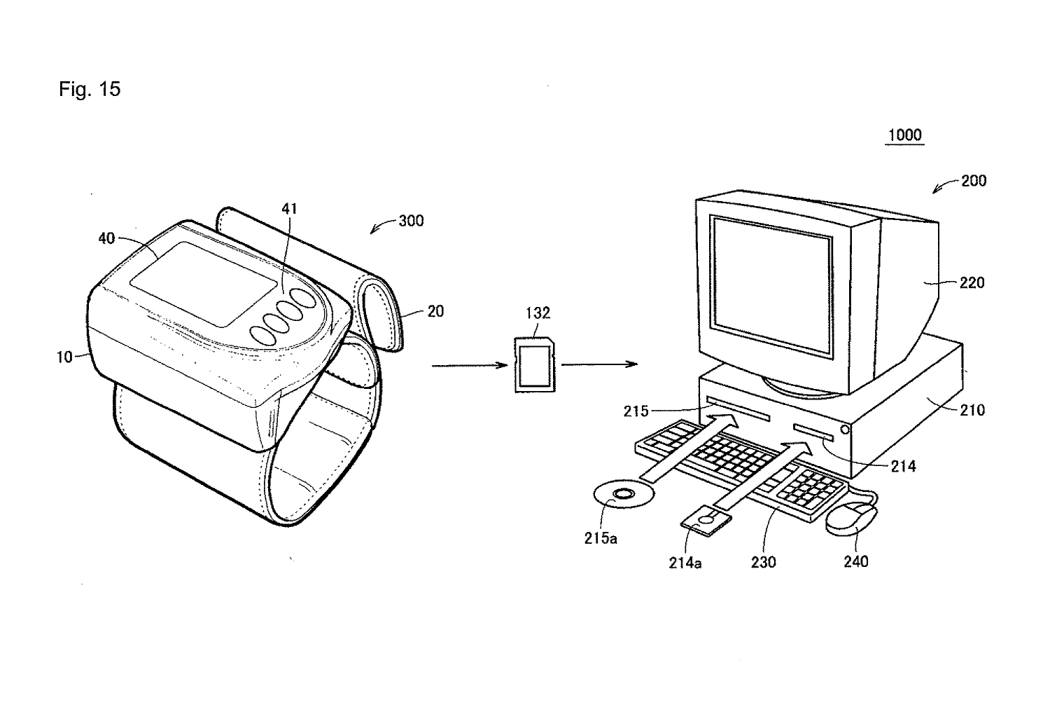

FIG. 15 is a view showing a concept of a biological information display system 1000 according to the second embodiment of the present invention.

With reference to FIG. 15, the biological information display system 1000 includes a biological information measurement device 300 and a biological information display device 200. The biological information measurement device 300 is used at homes outside hospitals. The biological information measurement device 300 records blood pressure measurement information in a removable recording medium 132. The biological information display device 200 reads out the blood pressure measurement information from the recording medium 132 to perform a calculation and display process on a statistical value based on blood pressures value measured in the biological information measurement device 300.

The biological information measurement device 300 may be a portable sphygmomanometer or the like. The hardware configuration of the biological information measurement device 300 is similar to the configuration shown in FIG. 2. However, the authentication information detection unit 48 may not be arranged therein. The biological information display device 200 according to the present embodiment may be an ordinary PC (personal computer).

The blood pressure measurement information recorded in the recording medium 132 includes a plurality of pieces of measurement result data shown in FIG. 8.

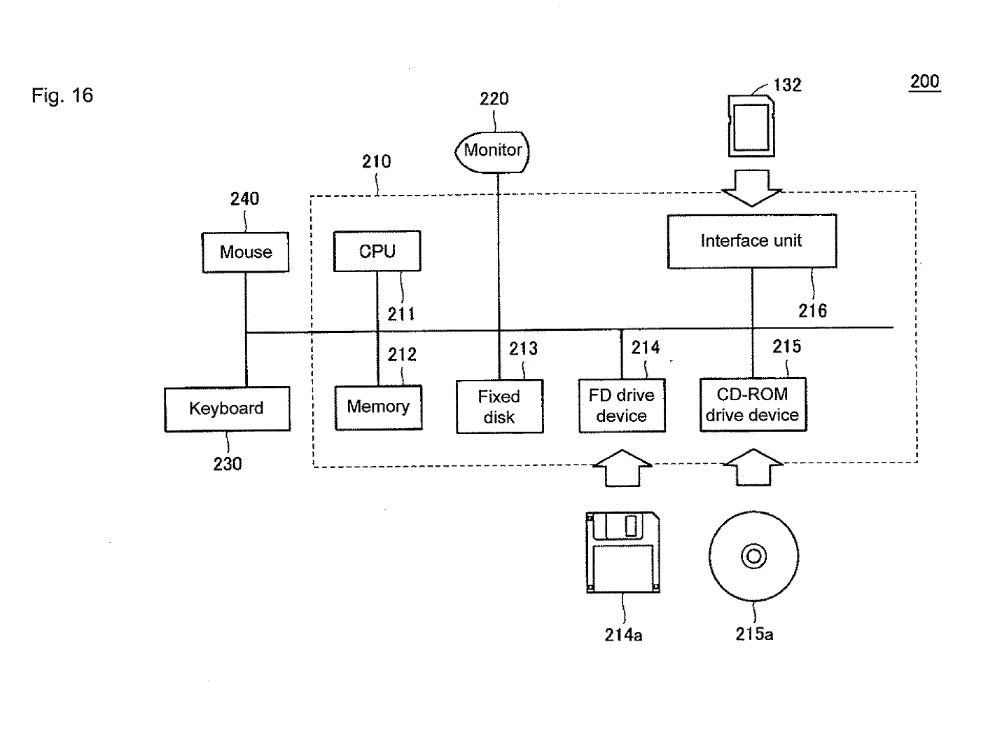

FIG. 16 is a hardware block diagram showing an example of the hardware configuration in the biological information display device 200.

With reference to FIG. 16, the biological information display device 200 includes a main body 210, a monitor 220, a keyboard 230, and a mouse 240, and the main body 210 includes a CPU 211, a memory 212, a fixed disk 213 serving as a storage device, an FD (Flexible Disk) drive device 214, a CD-ROM (Compact Disk-Read Only Memory) drive device 215, and an interface unit 216. These pieces of hardware are mutually connected by a bus.

An FD 214a is mounted in the FD drive device 214, and a CD-ROM 215a is mounted in the CD-ROM drive device 215. The biological information display device 200 according to the present embodiment is realized such that the CPU 211 executes software using the hardware such as the memory 212. Generally, such software is stored in a recording medium such as the FD 214a or the CD-ROM 215a, or is circulated through the network or the like. The software is read out of the recording medium by the FD drive device 214, the CD-ROM drive device 215, or the like, or is received by a communication interface (not shown) to be stored in the fixed disk 213, Furthermore, the software is read out of the fixed disk 213 to the memory 212, and is executed by the CPU 211.

The monitor 220 is a display unit for displaying the blood pressure information, and the like output by the CPU 211, and is configured by an LCD (Liquid Crystal Display), a CRT (Cathode Ray Tube), or the like. The mouse 240 receives a command from a user (representatively, a person making the diagnosis such as a medical specialist) according to the operation such as click or slide. The keyboard 230 receives a command from the user according to an input key. The CPU 211 is an arithmetic processing unit for performing various types of calculations by sequentially executing programmed commands. The memory 212 stores various types of information according to the execution of the program by the CPU 211. The interface unit 216 is a portion for receiving blood pressure measurement information by the biological information measurement device 300, and is configured by a slot, into which the recording medium 132 can be mounted, a peripheral circuit for controlling the slot, and the like in the present embodiment. The recording medium 132 may be configured as a communication interface capable of data communication with the biological information measurement device 300 in place of the slot into which the recording medium 132 can be mounted. The fixed disk 213 is a non-volatile storage device for storing the program to be executed by the CPU 211 and the blood pressure measurement information received from the biological information measurement device 300. Other output devices such as a printer may be connected to the biological information display device 200 as necessary.

The CPU 211 performs the control on the specification of the blood pressure value to be used in the Calculation of the statistical value, the calculation and display of the statistical value, and the like, based on the blood pressure measurement information stored in the fixed disk 213.

The CPU 100 of the biological information measurement device 300 includes at least the function of the measurement processing unit 102 out of the functional blocks of the first embodiment shown in FIG. 3. Specifically, the CPU 100 executes the processing in the steps S102 to S110 in the flowchart of FIG. 7. In step S109, the measurement result may be directly recorded in the recording medium 132. If the biological information measurement device 300 does not have the continuous measurement function, the processing in step S110 (determination on the number of times) may not be executed.

The CPU 211 of the biological information display device 200 includes at least the functions of the specification control unit 104 and the statistical value calculating unit 106 out of the functional blocks of the first embodiment shown in FIG. 3. The CPU 211 reads out the measurement result data for N times measured most recently from the fixed disk 213, and executes a series of statistical process shown in the flowchart of FIG. 10.

Alternatively, the statistical processing method performed by the biological information display devices 1, 200 described above may be provided as a program. The program according to the present invention may be to call out a necessary module out of program modules provided as part of the operating system (OS) of the computer in a predetermined array and at a predetermined timing, and to execute the process. In such a case, the program itself does not include the above-described module, and the process is executed in cooperation with the OS. The program that does not include such a module is also applicable to the program according to the present invention.

The program according to the present invention may be provided by being incorporated as part of a different program. In this case as well, the module included in the different program is not included in the program itself, and the process is executed in cooperation with the different program. Such a program incorporated in a different program is also applicable to the program according to the present invention.

The embodiments disclosed herein are illustrative in all aspects and should not be construed as being restrictive. The scope of the present invention is defined by the claims rather than by the description made above, and all modifications equivalent in meaning to the claims and within the scope thereof are intended to be encompassed therein.

### DESCRIPTION OF SYMBOLS

1, 200 biological information display device

10 main body

20 cuff

21 air bag

30 air system

31 air tube

32 pressure sensor

33 oscillation circuit

34 valve

40 display unit

41 operation unit

41A power switch

41B measurement switch

41C set switch

41D cursor switch

43 memory

43 flash memory

44 power supply

45 timer unit

46 data input/output unit

48 authentication information detection unit

50 adjustment unit

51 pump

52 valve

53 pump drive circuit

54 valve drive circuit

100 CPU

102 measurement processing unit

104 specification control unit

106 statistical value calculating unit

112 reliability rate calculating portion

114 extracting portion

116 specification processing portion

132 recording medium

210 main body

211 CPU

212 memory

213 fixed disk

214 FD drive device

215 CD-ROM drive device

216 interface unit

220 monitor

230 keyboard

240 mouse

300 biological information measurement device

411 leftward switch

412 rightward switch

413 upward switch

414 downward switch

415 determination switch

1000 biological information display system

1. A biological information display device (1, 200) capable of calculating and displaying a statistical value of measurement results for a plurality of times on biological information, the biological information display device comprising:
a display unit (40);
an operation unit (41) for receiving an instruction from a user;
a storage unit (43) for storing the measurement results of the biological information for the plurality of times as first measurement results; and
a specification control unit (104) for controlling to specify a second measurement result to be used in the calculation of the statistical value out of the first measurement results, wherein
the specification control unit includes a specification processing portion (116) for specifying the second measurement result based on instruction received by the operation unit when result information on the first measurement results is displayed,
a first calculating unit (106) for calculating the statistical value on the specified second measurement result is further included,
the display unit displays the calculated statistical value,
the specification processing portion specifies the measurement result other than the specified measurement result as the second measurement result when the received instruction indicates specification of data to be eliminated out of the first measurement results, and
the specification processing portion specifies the specified measurement result as the second measurement result when the received instruction indicates specification of data to calculate out of the first measurement results.

2. The biological information display device according to claim 1, wherein
the first measurement results each include first measurement value data,
the specification control unit displays the first measurement value data on the display unit as the result information, and
the first calculating unit calculates the statistical value of second measurement value data contained in the respective second measurement results.

3. The biological information display device according to claim 2, wherein
each of the first measurement value data is data of a blood pressure value,
each of the first measurement results further includes a plurality of pieces of pulse wave amplitude value data and a plurality of pieces of pressure value data corresponding to the respective pieces of the plurality of pulse wave amplitude value data, and
the specification control unit displays a graph of the pulse wave amplitude along a cuff pressure axis on the display unit as the result information.

4. The biological information display device according to claim 3, further comprising:
a cuff (20) to be wrapped around a predetermined measurement site of a person to be measured;
an adjustment unit (50) for adjusting pressure in the cuff;
a detection unit (32) for detecting a cuff pressure representing the pressure in the cuff; and
a measurement processing unit (102) for measuring a blood pressure value of the person to be measured based on the cuff pressure detected by the detection unit.

5. The biological information display device according to claim 2, wherein
the specification control unit further includes a second calculating portion (112) for calculating a reliability rate of each of the measurement values based on the first measurement results, and
the display unit further displays the reliability rate in correspondence with each piece of the measurement value data as well as the result information.

6. The biological information display device according to claim 5, wherein
the specification control unit further includes an extracting portion (114) for extracting a specification candidate by the user out of the first measurement value data based on the reliability rate, and
the display unit displays the measurement value data extracted as the specification candidate so as to be identifiable from the other measurement value data when displaying the result information.

7. The biological information display device according to claim 1, wherein
the first measurement results each include the first measurement value data as data of a blood pressure value and pulse wave related information,
each pulse wave related information further includes a plurality of pieces of pulse wave amplitude value data and a plurality of pieces of pressure value data corresponding to each of the plurality of pieces of pulse wave amplitude value data, and
the specification control unit displays a graph of the pulse wave amplitude along a cuff pressure axis on the display unit as the result information for each of the first measurement results based on the pulse wave related information.

8. The biological information display device according to claim 7, wherein the first calculating unit calculates a statistical value of a pulse waveform contained in each of the second measurement results.

9. The biological information display device according to claim 1, wherein the first measurement results represent measurement results for a predetermined number of times.

10. The biological information display device according to claim 1, wherein the first measurement results represent the measurement results corresponding to a classification type specified by the user.

11. The biological information display device according to claim 10, wherein the classification type is defined in advance as at least one of a time band, identification information of a person to be measured, and a measurement condition.

12. A biological information display system (1000) comprising a biological information measurement device (300) and a biological information display device (200),
the biological information measurement device including:
a measurement processing unit (102) for measuring biological information of a person to be measured; and
an output unit (46) for outputting first measurement results for a plurality of times measured by the measurement processing unit,
the biological information display device including:
an input unit (216) for inputting the first measurement results;
a display unit (220);
an operation unit (230, 240) for receiving an instruction from a user; and
a specification control unit (104) for controlling to specify a second measurement result to use in calculation of a statistical value out of the first measurement results, wherein
the specification control unit includes a specification processing portion (116) for specifying the second measurement result based on instruction received by the operation unit when result information on the first measurement results is displayed,
a first calculating unit (106) for calculating the statistical value of the specified second measurement result is further included,
the display unit displays the calculated statistical value,
the specification processing portion specifies the measurement result other than the specified measurement result as the second measurement result when the received instruction indicates specification of data to be eliminated out of the first measurement results, and
the specification processing portion specifies the specified measurement result as the second measurement result when the received instruction indicates specification of data to calculate out of the first measurement results.

13. A statistical processing method for calculating and displaying a statistical value of measurement results for a plurality of times on biological information, the method comprising the steps of:
displaying result information on the first measurement results for a plurality of times (S202);
specifying a plurality of second measurement results to use in the calculation of the statistical value out of the first measurement results based on instruction from the user when the result information is displayed;
calculating the statistical value on the specified second measurement results (S208); and
displaying the calculated statistical value (S210), wherein
in the specifying step, the measurement result other than the specified measurement result is specified as the second measurement result when the instruction indicates specification of data to be eliminated out of the first measurement results, and
in the specifying step, the specified measurement result is specified as the second measurement result when the instruction indicates specification of data to calculate out of the first measurement results.

14. A recording medium recording thereon a statistical processing program for calculating and displaying a statistical value of measurement results for a plurality of times on biological information, the program causing a computer to execute the steps of:
displaying result information on the first measurement results for a plurality of times (S202);
specifying a plurality of second measurement results to use in the calculation of the statistical value out of the first measurement results based on instruction from the user when the result information is displayed;
calculating the statistical value on the specified second measurement results (S208); and
displaying the calculated statistical value (S210), wherein in the specifying step, the measurement result other than the specified measurement result is specified as the second measurement result when the instruction indicates specification of data to be eliminated out of the first measurement results, and
in the specifying step, the specified measurement result is specified as the second measurement result when the instruction indicates specification of data to calculate out of the first measurement results.
